(19) United States
(12) Patent Application Publication
(10) Pub. No.: US 2010/0159260 A1
(43) Pub. Date: Jun. 24, 2010

(54) CHROME-FREE METHOD OF CONDITIONING AND ETCHING OF A THERMOPLASTIC SUBSTRATE FOR METAL PLATING

(75) Inventors: Andri E. Elia, Chadds Ford, PA (US); Claudio Pierdomenico, Meyrin Geneva (CH); Mariane Zebri, Cruseilles (FR)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 12/630,003

(22) Filed: Dec. 3, 2009

Related U.S. Application Data
(60) Provisional application No. 61/140,384, filed on Dec. 23, 2008.

(51) Int. Cl. B05D 3/10; B44C 1/22; C25D 5/56; C25D 7/00; B32B 15/08

(52) U.S. Cl. 428/458; 216/83; 427/307; 205/164; 205/50

(57) ABSTRACT

Described is an improved process for the simultaneous conditioning and etching of a thermoplastic substrate for metal plating using sulfuric acid dissolved in a solvent.

### CROSS REFERENCE TO RELATED APPLICATIONS

This application claims the benefit of U.S. Provisional Application No. 61/140,384, filed Dec. 23, 2008, which is incorporated herein by reference in its entirety.

### FIELD OF THE INVENTION

An improved chromium(VI)-free process for the simultaneous conditioning and etching of a thermoplastic substrate for metal plating.

### BACKGROUND OF THE INVENTION

It is well known in the art, and practiced commercially, to coat thermoplastic polymers (TPs) with metals. Such coatings are utilized for aesthetic purposes (i.e., chrome plating), to improve the mechanical properties of the polymeric substrate, and to provide other improved properties such as electromagnetic shielding. The metal may be put onto the TP using a variety of methods, such as electroless or electrolytic plating, vacuum metallization, different sputtering methods, lamination of metal foil onto the thermoplastic, etc.

Using any of these methods the resulting product must have certain properties to be useful. Generally speaking the metal coating should have sufficient adhesion so that it does not separate from the thermoplastic substrate during use. This may be particularly difficult if the product must undergo temperature cycling, that is repeated heating and cooling above and/or below ambient temperature. Since most thermoplastic compositions have different thermal coefficients of expansion than most metals, the repeated heating and cooling cycles may stress the interface between the metal and TP, resulting in weakening the bonding between the TP and metal coating, and eventually in separation of the TP and metal layer. Therefore process methods and/or compositions for improving the adhesion of TPs to metal coatings, especially in a thermal cycling environment, are desired.

Adhesion to the substrate can be improved by the use of conditioning/and or etching of the substrate before coating. A standard etching material known in the art is sulfochromic acid. This, however has the drawback of chromium VI which is environmentally harmful. It has been found that the use of sulfuric acid, which contains no chromium VI, in a suitable solvent can simultaneously condition and etch the TP substrate, leading to improved adhesion.

### SUMMARY OF THE INVENTION

Described herein is a process for the simultaneous conditioning and etching of at least part or all of a surface of a thermoplastic polymer substrate for metal plating, comprising contacting the surface of the substrate with a solution comprising sulfuric acid in a suitable solvent.

### DETAILED DESCRIPTION

Described herein is a process for the simultaneous conditioning and etching of a surface of a thermoplastic polymer substrate for plating, comprising contacting the surface of the substrate with a solution comprising sulfuric acid in a suitable solvent. The process can be performed on all or part of the surface of the substrate.

By the “thermoplastic polymer” (TP) is the common meaning an organic polymeric material that is not crosslinked and which has a glass transition temperature (Tg) and/or melting point (Tm) above 30° C. Herein Tm's and Tg's are measured using ASTM Method D3418-82, using a temperature heating rate of 25° C./min. Measurements are made on the second heat. The Tm is taken as the peak of the melting endotherm, while the Tg is taken as the inflection point of the transition. To be considered a Tm, the heat of melting for any melting point should be at least about 1.0 J/g.

Useful TPs can include blends of thermoplastic polymers, including blends of two or more semicrystalline or amorphous polymers, or blends containing both semicrystalline and amorphous thermoplastics. A preferred amorphous TP is ABS (acrylonitrile-butadiene-styrene) polymers.

By a “semicrystalline thermoplastic polymer” is meant a thermoplastic which has a melting point above 30° C. with a heat of melting of at least about 2.0 μg, more preferably at least about 5.0 μg.

Semicrystalline TPs are preferred, and include polymers such as poly(oxymethylene) and its copolymers; polyesters such as polyethylene terephthalate), poly(1,4-butylene terephthalate), poly(1,4-cyclohexyldimethylene terephthalate), and poly(1,3-poropyleneterephthalate); polyamides such as nylon-6,6, nylon-6, nylon-12, nylon-11, nylon-10, and partially aromatic (co)polyamides; polyolefins such as polyethylene (i.e. all forms such as low density, linear low density, high density, etc.), polypropylene but not limited to these.

The preferred TP is a polyamide typically a partially aromatic polyamide. The polyamide can also comprise an aliphatic polyamide and a partially aromatic polyamide.

By a “partially aromatic polyamide” (PAP) is meant a polyamide derived in part from one or more aromatic dicarboxylic acids, where the total aromatic dicarboxylic acid is at least 50 mole percent, preferably at least 80 mole percent and more preferably essentially all of the dicarboxylic acid(s) from which the polyamide is derived from are aromatic dicarboxylic acids. Preferred aromatic dicarboxylic acids are terephthalic acid and isophthalic acid, and their combinations.

By an “aliphatic polyamide” (AP) is meant a polyamide derived from one or more aliphatic diamines and one or more dicarboxylic acids, and/or one or more aliphatic lactams, provided that of the total dicarboxylic acid derived units present less than 60 mole percent, more preferably less than 20 mole percent, and especially preferably essentially no units derived from aromatic dicarboxylic acids are present.

By an “aliphatic diamine” is meant a compound in which each of the amino groups is bound to an aliphatic carbon atom. Useful aliphatic diamines include diamines of the formula H₂N(CH₂)ₙNH₂ wherein n is 4 through 12, and 2-methyl-1,5-pentanediamine.

By an “aromatic dicarboxylic acid” is meant a compound in which each of the carboxyl groups is bound to a carbon atom which is part of an aromatic ring. Useful dicarboxylic acids include terephthalic acid, isophthalic acid, 4,4′-biphenyldicarboxylic acid, and 2,6-naphthalenedicarboxylic acid.

Preferred PAPs are those which comprise repeat units derived from one or more of the dicarboxylic acids isophthalic acid, terephthalic acid, adipic acid, and one or more of the diamines H₂N(CH₂)ₙNH₂ wherein n is 4 through 12, and 2-methylpentanediamine. It is to be understood that any combination of these repeat units may be formed to form a preferred PAP.

Preferred APs are those which comprise repeat units derived from one or more dicarboxylic acids, of the formula HO₂C(CH₂)ₘCO₂H wherein m is 2 to 12, isophthalic acid, and terephthalic acid. In an especially preferred dicarboxylic acid is adipic acid (m=4). In these preferred APs comprise the preferred repeat units from diamines are derived from H₂N(CH₂)ₙNH₂ wherein n is 4 through 12, and 2-methylpentanediamine, and the diamine wherein n is 6 is especially preferred. It is to be understood that any combination of these repeat units may be formed to form a preferred AP. Especially preferred specific APs are polyamide-6,6 and polyamide-6 [poly(ε-caprolactam)] and polyamide 10.

In preferred PAPs, the TP has a Tg and/or Tm of about 90° C. or more, preferably about 140° C. or more, and especially preferably about 200° C. or more. Preferably the TP is at least 30 weight percent of the total composition, more preferably at least 50 weight percent of the total composition. It is to be understood that more than one TP may be present in the composition, and the amount of TP present is taken as the total amount of TP(s) present.

The TP composition to be metal plated may also contain other materials normally found in thermoplastic TP compositions in the usual amounts such as (note—classification of some of these specific materials may be somewhat arbitrary and sometimes these materials may fulfill more than one function): reinforcing agents such as glass fiber, carbon fiber, aramid fiber, milled glass, flat glass, and wollastonite; fillers such as clay, mica, carbon black, silica, and other silicate minerals; flame retardants; pigments; coloring agents; stabilizers (optical and/or thermal); antioxidants; lubricants and/or mold release; adhesion promotion (especially between the TP composition and metal coating) agents; tougheners including polymeric tougheners, other polymers such as polyesters and amorphous polyamides. Preferred materials are reinforcing agents especially glass fiber and carbon fiber. It is to be understood that more than one of each type of these materials may be present, and that more than one type of the above materials may also be present.

The TP can also contain an etchable filler. By an “etchable filler” is meant a filler which is at least partially removed and/or whose surface is altered by appropriate (acid, base, thermal, solvent, etc.) treatment, under conditions which do not significantly deleteriously affect the polymeric substrate. By this meant that fillers is removed, in part or totally, from the surface of the polymeric part by the treatment applied. For example the filler may be material such as calcium carbonate or zinc oxide which can be removed (etched) by aqueous hydrochloric acid, or a material such as zinc oxide or citric acid which may be removed by aqueous base, or a material such as poly(methyl methacrylate) which can be depolymerized and removed at high temperatures, or citric acid or sodium chloride which can be removed by a solvent such as water. Since the polymeric matrix will normally not be greatly affected by the treatment, usually only the etchable filler near the surface of the polymeric part will be affected (fully or partially removed). What materials will be etchable fillers in any [particular situation will be determined by the conditions used for the etching, including things such as the etchant (thermal, solvent, chemical), and the physical conditions under which the etching is carried out. For example for any particular polymer etching should not be carried out at a temperature high enough to cause extensive thermal degradation of the matrix polymer, and/or the matrix polymer should not be exposed to a chemical agent which extensively attacks the polymeric matrix, and/or to a solvent which readily dissolves the polymeric matrix. Some very minor “damage” to the polymeric matrix may be acceptable, and indeed a small amount of etching of the polymeric matrix surface itself due to “attack” on the polymer itself may be useful in improving adhesion of whatever is (later) coated onto the polymeric surface.

The etchable filler is a preferred ingredient, especially when the metal coating is to be done by electroless coating and/or electrolytic coating. The TP can contain about 0.5 to about 30 weight percent of the etchable filler. Preferred etchable fillers are alkali metal carbonate and alkaline earth (Group 2 elements, IUPAC Notation) carbonates, and calcium carbonate is especially preferred. Preferably the minimum amount of etchable filler is 0.5 weight percent or more, more preferably about 1.0 weight percent or more, very preferably about 2.0 weight percent or more, and especially preferably about 5.0 weight percent or more. The preferred maximum amount of etchable filler present is about 30 weight percent or less, more preferably about 15 weight percent or less, and especially preferably about 10 weight percent or less. These weight percents are based on the total TP composition. It is to be understood that any of these minimum weight percents can be combined with any of the maximum weight percents to form a preferred weight range for etchable filler. More than one etchable filler may be present, and if more than one is present, then the amount of etchable filler is taken as the total of those present.

The TP compositions may be made by those methods which are used in the art to make TP compositions in general, and are well known. Most commonly the TP itself will be melt mixed with the various ingredients in a suitable apparatus, such as a single or twin screw extruder or a kneader. In order to prevent extensive degradation of the flat reinforcing fiber length it may be preferable to “side feed” the fiber, as in a twin screw extruder, so the fiber is not exposed to the high shear of the is entire length of the extruder.

Parts may be formed by the usual forming methods for TP compositions such as injection molding, extrusion, blow molding, thermoforming, rotomolding, etc. Again these methods are well known in the art.

In the process described herein, the acid etch is dissolved in a suitable solvent. A suitable solvent is one that is not detrimental to the TP substrate, can dissolve the acid etch, and can partially dissolve and/or swell the TP at a range of temperature that may be above room temperature but below the TPs melting point. Typical suitable solvents for polyamides include phenols, such as but not limited to cresol (methyl phenol) and metacresol, and ethylene glycol; and also include some acids such as formic acid, acetic acid. The acid etch can be sulfuric acid, phosphoric acid, phosphorus acid, phosphinic acid or combinations thereof.

The acid etch or aqueous solution of the acid etch can be gradually added to the solvent in a fume hood while keeping the solution temperature below a nominal 80° C. or another safe temperature, until a concentration of acid in the solvent is reached of about 180 to about 700 gr/liter, or preferably about 200 to about 550 g/liter as determined by the volume and concentration of the aqueous acid solution added to the volume of the solvent. The final concentration of acid after agitation, as measured by titration with sodium hydroxide, is typically about 90 to about 350 gr/liter, preferably about 100 to about 275 gr/liter

The surface of the TP substrate is prepared and etched by contacting at least part or all of the surface with the thus prepared acid etch solution under agitation. The temperature of the solution during contacting is typically about 50° C. to about 100° C., or about 70° C. to about 90° C., or about 75° C. to about 85° C.

The contacting is typically done for a period of about 3 to about 25 minutes, or about 5 to about 20 minutes, or about 10 minutes.

The process can also include a further step or steps of activation where part or all of the TP substrate surface can be activated by treatment with a “catalyst”, typically a palladium compound, followed by an electroless plating solution which deposits a layer of metal such as nickel or copper onto the surface of the TP. If a thicker and/or additional metal layer is desired, the process can further comprise the step of plating part or all of the surface using any method known in the art, such as electroless, electrolytic, or combination thereof. Suitable catalyst and other methods for applying the metal coating to the TP substrate are well known, see for instance U.S. Pat. Nos. 5,762,777, 6,299,942 and 6,570,085. Multiple layers of metals may be applied, of the same or differing compositions.

Useful metals which may be coated onto the TP include copper, manganese, tin, nickel, iron, zinc, gold, platinum, cobalt, and phosphorus, and alloys of these metals. These metals may be readily coated using electroless and/or electrolytic coating methods, while aluminum is commonly used in vacuum metallization. The coating may be of any thickness achievable by the various coating methods, but will typically be about 1 to about 300 μm thick, preferably about 1 to about 100 μm thick. Average grain size of the metals deposited may range from 1 nm to about 15,000 nm. One preferred average grain size range is 1 nm to 100 nm. The effect of the metal coating may, for example, be one or more of improved aesthetics, improved mechanical properties, increased electromagnetic shielding, improved protection of the TP from a corrosive environment, and/or repeated exposure to thermal and rapid cooling cycles.

These metal coated compositions are useful in various articles such as automotive parts especially in high temperature environment with optional heat and cooling cycling requirements, in electronics as in hand held devices, toys, appliances, power tools, industrial machinery, and the like.

### EXAMPLES

All parts herein are parts by weight.

The materials used are:

Polyamide composition 1

| | |
|---|---|
| Polymer A | 55% |
| Filler 1 | 40% |
| Toughener | 5% |

Polyamide composition 2

| | |
|---|---|
| Polymer A | 47.32% |
| Polymer B | 2% |
| GF | 40% |
| Filler 2 | 10% |
| Additive 1 (HS 7:1:1) | 0.43% this is heat stabilizer (Joel describes) |
| Additive 2 (Licowax OP) | 0.25% this is lubricant |

Polyamide composition 3

| | |
|---|---|
| Polymer A | 34.32% |
| GF | 25% |
| Filler 3 | 40% |
| Additive 1 (HS 7:1:1) | 0.43% this is heat stabilizer (Joel describes) |
| Additive 2 (Licowax OP) | 0.25% this is lubricant |

Polymer A—a PAP made from terephthalic acid, 50 mole percent (of the total diamine present) of 1,6-hexanediamine, and 50 mole percent of 2-methyl-1,5-pentanediamine.
Polymer B—an aliphatic polyamide, lower molecular weight polyamide-6,6, Elvamid® 8061 available from E.I. DuPont de Nemours & Co., Inc. Wilmington, Del. 19899 USA.
Filler 1—A calcined, surface treated kaolin, Translink® 445, available from BASF, Florham Park, N.J.
Filler 2—Calcium Carbonate, Super-Pflex®200 available from Specialty Mineral Inc., New York, N.Y. 10174, USA.
Filler 3—A Wollastonite Nyad® G10012, available from NYCO, Willsboro, N.Y. 12996 U.S.A
Toughener—EPDM, from E.I. DuPont de Nemours & Co., Inc. Wilmington, Del. 19899
GF—Chopped glass fiber, PPG® 3660, available from PPG Industries, Pittsburgh, Pa. 15272, USA.

Example partially aromatic polyamide (PAP) compositions 1, 2, 3 were etched by contacting their entire surfaces with a sulfuric acid solution in ethylene glycol, for 10 minutes at a temperature of 80 C, where the sulfuric acid solution in ethylene glycol was prepared by gradual addition of 3 liters of 98% aqueous sulfuric acid to 10 liters of ethylene glycol. The thus surface prepared PAPs were subsequently activated and electrolessly plated with Ni via the process described in Table 1, after which they were electroplated with Cu, also by the process described in Table 1. Table 2 describes a process that also works in producing sufficient peel strength between the plastic surface and the electroplated Cu metal layer; the etching is also accomplished with sulfuric acid in ethylen glycol as described above, while the subsequent steps of activation and electroless Ni plating are different, with the electroplating of Cu being the same.

The positive comparative examples were prepared by the process of Table 3, where the etching solution was sulfochromic acid with the subsequent steps being the same as the process in Table 2.

The negative comparative examples were prepared by the process shown in Table 4, where the etching solution comprises hydrochloric acid in ethylene glycol and the subsequent steps are the same as in the process described in Table 1.

TABLE 1
Process using an activation with an ionic palladium

| Step | | | | | | Temp. | |
|---|---|---|---|---|---|---|---|
| No. | Bath | Vol. L | Additives | Filtration | Stirring | ° C.^{a} | Time^{b} |
| 1 | Etching | 4 | H₂SO₄ in | No | Mechanical | 80 | 10′ |
| | | | ethylene glycol | | and/or Air | | |
| 2 | Rinsing | 25 | H₂O | No | No | RT | 2′ |
| 3 | Ultrasonic | 25 | H₂O | No | No | RT | 5′-15′ |
| 4 | Rinsing | 25 | H₂O | No | No | RT | 1′ |
| 5 | Activator | 4 | PM857^{c} | No | Mechanical | 30 | 5′-10′ |
| | | | (300 ppm Pd) | | | | |
| 6 | Rinsing | 25 | H₂O | No | No | RT | 1′ |
| 7 | Accelerator | 25 | PM867 | No | Mechanical | 30 | 1′-3′ |
| 8 | Rinsing | 25 | H₂O | No | No | RT | 1′ |
| 9 | Chemical Ni | 25 | PM980^{c} R&S | Yes | 1′ no/pump | 45 | 10′-30′ |
| | PM980 | | | | | | |
| 10 | Rinsing | 25 | H₂O | No | No | RT | 1′ |
| 11 | Galvanic | 45 | CuSO₄ | Yes | Mechanical/air | RT | 40′ |
| | Copper | | | | | | |
| 12 | Rinsing | 25 | H₂O | No | | RT | 1′ |

^{a}RT indicates room temperature
^{b}minutes (′) and seconds (″)
^{c}Available from Rohm & Haas Electronic Materials Europe, Coventry CV3 2RQ, Great Britain

TABLE 2
Process using an activation with DP palladium/tin

| Step | | | | | | Temp. | |
|---|---|---|---|---|---|---|---|
| No. | Bath | Vol. L | Additives | Filtration | Stirring | ° C.^{a} | Time^{b} |
| 1 | Etching | 4 | H₂SO₄ in ethylene | No | Mechanical | 70-85 | 5-15′ |
| | | | glycol | | and/or Air | | |
| 2 | Rinsing | 20 | H₂O | No | No | RT | 2 × 30″ |
| 3 | Ultrasonic | 25 | H₂O | No | No | RT | 5′-15′ |
| 4 | Rinsing | 25 | H₂O | No | No | RT | 1′ |
| 5 | Pre-dip | 25 | H₂O | HCl10% | No | No | RT |
| | | | | vol/vol | | | |
| 6 | Activator | 4 | Conductron DP | No | No/Mechanical | 30 | 1′-10′ |
| | | | (35 ppm Pd) | | | | |
| 7 | Rinsing | 25 | H₂O | No | No | RT | 2′ |
| 8 | Accelerator | 25 | PM964^{c} | No | Air | 45 | 2′-10′ |
| 9 | Rinsing | 25 | H₂O | No | No | RT | 1′ |
| 10 | Chemical Ni | 25 | PM980^{c} R&S | Yes | 1′ no/pump | 30 | 10′-30 |
| | PM980 | | | | | | |
| 11 | Rinsing | 25 | H₂O | No | No | RT | 1′ |
| 12 | Galvanic | 45 | CuSO₄ | Yes | Mechanical/air | RT | 40′ |
| | Copper | | | | | | |
| 13 | Rinsing | 25 | H₂O | No | No | RT | 1′ |

^{a}RT indicates room temperature
^{b}minutes (′) and seconds (″)
^{c}Available from Rohm & Haas Electronic Materials Europe, Coventry CV3 2RQ, Great Britain

TABLE 3
Positive comparative examples

| Step | | | | |
|---|---|---|---|---|
| No. | Bath Type | Additives^{a} | Temp. ° C.^{b} | Time, min. |
| 1 | Etching | Sulfochromic | 50-80 | 5-20 |
| | | acid | | |
| 2 | Rinse | | | 0.5 twice |
| 3 | Static Rinse | | | 1 |
| 4 | Rinse | | | 1 |
| 5 | Neutralization | Neutraliser | 55 | 2-5 |
| | | PM955^{c} | | |
| 6 | Rinse | | | 1 |
| 7 | GRZ etch | | | 3-5 |
| 8 | Rinse | | | 1 |
| 9 | Pre-dip | 10% HCl (v/v) | | 0.5 |
| 10 | Activator | Conductron ® | 30 | 1-10 |
| | | DP (35 ppm Pd)^{c} | | |
| 11 | Rinse | | | 2 |
| 12 | Accelerator | Accelerator | 45 | 2-10 |
| | | PM964^{c} | | |
| 13 | Rinse | | | 1 |
| 14 | Chemical Ni PM | PM 980 R&S^{c} | 30 | 10-30 |
| 15 | Rinse | | | 1 |
| 16 | Galvanic Cu | CuSO₄ | | 40 |
| 17 | Rinse | | | 1 |

^{a}If no additive listed, water used.
^{b}If no temperature listed, room temperature used.
^{c}This material available from Rohm & Haas Electronic Materials Europe, Coventry CV3 2RQ, Great Britain

TABLE 4
Negative comparative examples

| Step | | | | | | Temp. | |
|---|---|---|---|---|---|---|---|
| No. | Bath | Vol. L | Additives | Filtration | Stirring | ° C.^{a} | Time^{b} |
| 1 | Etching | 25 | PM847^{c} | Yes | Mechanical | 35-50 | 5′-20′ |
| 2 | Rinsing | 25 | H₂O | No | No | RT | 2′ |
| 3 | Ultrasonic | 25 | H₂O | No | No | RT | 5′-15′ |
| 4 | Rinsing | 25 | H₂O | No | No | RT | 1′ |
| 5 | Activator | 4 | PM857^{c} | No | Mechanical | 30 | 5′-10′ |
| | | | (150 ppm Pd) | | | | |
| 6 | Rinsing | 25 | H₂O | No | No | RT | 2′ |
| 7 | Accelerator | 25 | PM867^{c} | No | Mechanical | 30 | 1′-3′ |
| 8 | Rinsing | 25 | H₂O | No | No | RT | 1′ |
| 9 | Chemical Ni | 25 | PM980 R&S^{c} | Yes | 1′ no/pump | 45 | 10′-30′ |
| | PM980 | | | | | | |
| 10 | Rinsing | 25 | H₂O | No | No | RT | 1′ |
| 11 | Galvanic | 45 | CuSO₄ | Yes | Mechanical/air | RT | 40′ |
| | Copper | | | | | | |
| 12 | Rinsing | 25 | H₂O | No | No | RT | 1′ |
| 13 | Galvanic Ni | 45 | NiSO₄ | Yes | Mechanical/air | 55 | 10′-20′ |
| 14 | Rinsing | 25 | H₂O | No | No | RT | 1′ |

^{a}RT indicates room temperature
^{b}minutes (′) and seconds (′)
^{c}Available from Rohm & Haas Electronic Materials Europe, Coventry CV3 2RQ, Great Britain

The three PAP compositions in the examples were made by mixing the ingredients in a 30 mm Werner & Pfleiderer twin screw extruder. The PAPs were fed to the rear section, the glass fiber and filler(s) being fed downstream into the molten polyamide. The barrels were maintained at a nominal temperature of 310° C. Upon exiting the extruder through a strand die the compositions were pelletized. Subsequently the polyamide compositions were injection molded into 6 cm×6 cm×0.2 cm plaques. Injection molding conditions were drying at 100° C. for 6-8 h in dehumidified air, melt temperature 320-330° C., and mold temperature 140-160° C.

The peel strength was the adhesion measured by Zwick® (or equivalent device) Z005 tensile tester with a load cell of 2.5 kN using ISO test Method 34-1. A plaque of the thermoplastic composition was electroplated with 20-25 μm of metal (copper) standard galvanic cell fixed on a sliding table which is attached to one end of the tensile tester. Two parallel cuts 1 cm apart were made into the metal surface so that a band of metal on the thermoplastic surface 1 cm wide is created. The table slid in a direction parallel to the cuts. The 1 cm wide copper strip was attached to the other end of the machine, and the metal strip was peeled (at a right angle) at a test speed of 50 mm/min (temperature 23° C., 50% RH). The peel strength was then calculated, and is shown in Table 4.

TABLE 4

| | Peel strength average (N/cm) | | |
|---|---|---|---|
| | | Examples - | Positive |
| | Negative | Sulfuric Acid | Comparative |
| | Comparative | (without | Examples |
| | Examples - | Chromium VI) | Sulfochromic acid |
| Polyamide | PM847^{c} Etch | in Ethylene | (with Chromium |
| Composition | Solution Process | Glycol Process | VI) Process |
| 1 | 0 | 9.54 | 7.3 |
| 2 | 0 | 7.97 | 6.9 |
| 3 | 0 | 7.73 | 4.5 |

What is claimed is:

1. A process for the simultaneous conditioning and etching of at least part or all of a surface of a thermoplastic polymer substrate for metal plating, comprising contacting the surface of the substrate with a solution comprising sulfuric acid in a suitable solvent.

2. The process of claim 1 wherein the thermoplastic substrate is a polyamide.

3. The process of claim 2 wherein the polyamide is a partially aromatic polyamide or partially aromatic polyamide in combination with aliphatic polyamide.

4. The process of claim 2 wherein the polyamide comprises repeat units derived from one or more of the dicarboxylic acids isophthalic acid, terephthalic acid, adipic acid, and one or more of the diamines H2N(CH2)nNH2 wherein n is 4 through 12, and 2-methylpentanediamine.

5. The process of claim 1 wherein the suitable solvent is ethylene glycol.

6. The process of claim 1 wherein the temperature of the solution is about 50° C. to about 100° C.

7. The process of claim 1 wherein the contacting is done for a period of about 3 to about 25 minutes.

8. The process of claim 1 further comprising the step or steps of activation in the presence of a catalyst.

9. The process of claim 1 further comprising the step of metal plating, wherein the metal plating is electroless, electrolytic, or combination thereof.

10. The metal plated article made by the process of claim 1.

11. The metal plated article made from the process of claim 1, wherein said metal is selected from the group consisting of copper, manganese, tin, nickel, iron, zinc, gold, platinum, cobalt, and phosphorus, aluminum and alloys of these metals.

12. The metal plated article of claim 10 wherein said article is suitable for use in high temperature applications, automotive parts, electronic devices, toys, appliances, power tools, or industrial machinery.
